(19) United States
(12) Patent Application Publication
(10) Pub. No.: US 2010/0158056 A1
(43) Pub. Date: Jun. 24, 2010

(54) SEMICONDUCTOR LASER DEVICE

(75) Inventors: Jae-Heon Shin, Daejeon (KR); Kyung-Hyun Park, Daejeon (KR); Nam-Je Kim, Daejeon (KR); Chul-Wook Lee, Daejeon (KR); Eun-Deok Sim, Daejeon (KR); Sang-Pil Han, Daejeon (KR); Yong-Soon Baek, Daejeon (KR)

Correspondence Address: RABIN & Berdo, PC, 1101 14TH STREET, NW, SUITE 500, WASHINGTON, DC, 20005, US

(73) Assignee: ELECTRONICS AND TELECOMMUNICATIONS RESEARCH INSTITUTE, Daejeon (KR)

(21) Appl. No.: 12/495,616

(22) Filed: Jun. 30, 2009

(30) Foreign Application Priority Data
Dec. 22, 2008 (KR) 10-2008-0130965

(51) Int. Cl. H01S 3/13

(52) U.S. Cl. 372/29.016; 372/29.023

(57) ABSTRACT

Provided is a semiconductor laser device including: a gain area where multi-wavelength lights are generated and gain are provided; a first reflection area where among the multi-wavelength lights, a first-wavelength light is reflected to the gain area in response to a first selection signal; a second reflection area where among the multi-wavelength lights, a second-wavelength light is reflected to the gain area; and a phase control area where a phase of the second-wavelength light is shifted in response to a phase control signal, the phase control area being disposed between the first reflection layer and the second reflection layer.

### CROSS-REFERENCE TO RELATED APPLICATIONS

This application claims priority from Korean Patent Application No. 10-2008-0130965 filed on Dec. 22, 2008 in the Korean Intellectual Property Office, the disclosure of which is incorporated herein by reference in its entirety.

### BACKGROUND OF THE INVENTION

1. Field of the Invention

The present invention relates to semiconductor optical devices and, more particularly, to a dual-wavelength semiconductor laser device capable of continuously tuning wavelength of output light.

2. Description of the Related Art

As a transmittance distance increases in an optical communication system, functional optical devices have been developed for selecting specific wavelengths, for example, distributed feedback laser diode and distributed Bragg reflector laser diode, which have a narrow oscillation spectrum. Especially, optical devices have filtered wavelengths by using a diffraction grating, and various types of diffraction grating structures have been published and proposed at present.

In a semiconductor-based optical device, the wavelength filtering is performed to reflect only a specific wavelength corresponding to the Bragg wavelength of a light wave passing the optical device due to the periodic change of a refractive index. The light wave of the reflected wavelength is fed-back to a gain area. As a result, only the specific wavelength oscillates. The semiconductor optical device having such functions is manufactured by, for example, a semiconductor crystal growth and re-growth process, a diffraction grating formation process, an etching process, and an electrode formation process. In development of light source for optical communication as well as light source for generating tetrahertz (THz) waves using photomixing, semiconductor optical devices can be manufactured at low costs and in mass quantities. Moreover, semiconductor optical devices are suitable for constitution of a small-sized system. In view of these advantages, semiconductor optical devices have been actively developed in recent years.

Until now, there are various means for generating THz waves such as a frequency-double technique, a backward wave oscillator, a photomixing technique, a carbon dioxide pumping gas laser, a quantum cascade laser, and a free electron laser.

Recently, the photomixing technique is increasingly becoming attractive because it incurs relatively low costs and can be driven at a room temperature. In the photomixing technique, a beating signal of two laser diodes having different oscillation wavelengths impinge on a photomixer to generate a THz wave having frequency corresponding to the beating period of the beating signals. However, it is necessary to continuously tune a wavelength of one of the two laser diodes. Besides, the photomixing technique needs bulky optical components such as a beam splitter or a mirror to synchronize two beams with each other and a movable and rotatable stage manipulating with accuracy below micrometer. The bulky optical components and the stage occupy some space in the equipment employing the photomixing technique to incur high costs. For this reason, there is a need for a dual wavelength semiconductor laser that is capable of continuously tuning any one of two wavelengths output from one laser diode. The dual wavelength semiconductor laser can make all of the above-mentioned components unnecessary, thereby significantly reducing the costs.

Until now, one of two outputs having different wavelengths is fixed while the other output is variable with discrete tuning such as mode hoping. Nevertheless, a dual wavelength optical device that is capable of continuously tuning a wavelength is strongly required to offer wider utilization.

### SUMMARY OF THE INVENTION

Embodiments of the present invention provide a dual wavelength laser device.

In some embodiments, the dual wavelength laser device may include a gain region where multi-wavelength lights are generated and gains are provided; a first reflection area where among the multi-wavelength lights, a first-wavelength light is reflected to the gain area in response to a first selection signal; a second reflection area where among the multi-wavelength lights, a second-wavelength light is reflected to the gain area; and a phase control area where a phase of the second-wavelength light is shifted in response to a phase control signal, the phase control area being disposed between the first reflection area and the second reflection area.

### BRIEF DESCRIPTION OF THE DRAWINGS

The above and other features and advantages of the present invention will become more apparent by describing in detail preferred embodiments thereof with reference to the attached drawings in which:

FIG. 1 is a cross-sectional view of a semiconductor laser device according to some embodiments of the present invention;

FIG. 2 is a flowchart illustrating a method of controlling the semiconductor laser device shown in FIG. 1; and

FIG. 3 is a cross-sectional view of a semiconductor laser device according to other embodiments of the present invention.

### DESCRIPTION OF THE PREFERRED EMBODIMENTS

Advantages and features of the present invention and methods of accomplishing the same may be understood more readily by reference to the following detailed description of preferred embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims.

It will be understood that when any layer is referred to as being “on” the other layer or substrate, it may be directly formed on the other layer or substrate or intervening layers may be present. In addition, the thickness of layer and region is exaggerated for clarity. Further, it will be understood that, although the terms first, second, third, etc. may be used herein to describe various regions, layers, and so on, these regions and layers should not be limited by these terms. These terms are only used to distinguish one region and layer from another region and layer. Thus, a first layer discussed below could be termed a second layer without departing from the teachings of example embodiments. Each embodiment illustrated and described herein includes complementary embodiment thereof.

The present invention will now be described more fully with reference to the accompanying drawings, in which preferred embodiments of the invention are shown.

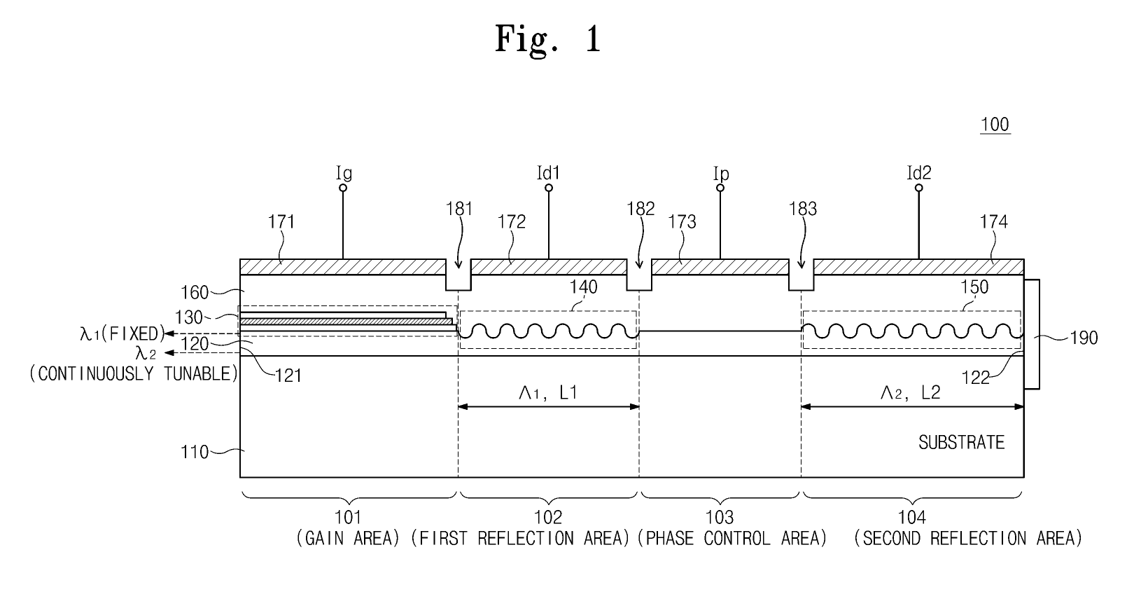

FIG. 1 is a cross sectional view illustrating the configuration a semiconductor laser device 100 according to some embodiments of the invention. The semiconductor laser device 100 includes a gain area 101, a first reflection area 102, a phase control area 103, and a second reflection area 104.

The gain area 101 includes a waveguide layer 120 disposed on the substrate 110. An active layer 130 is disposed on the waveguide layer 120, and a clad layer 160 is disposed on the active layer 130. An upper electrode 171 is disposed on the clad layer 160. Gain current Ig is supplied through the upper electrode 171. Although not illustrated in FIG. 1, an ohmic layer may be disposed between the upper electrode 171 and the clad layer 160.

The waveguide layer 120 is made of a material having a higher refractive index than the substrate 110 or the clad layer 160. Moreover, the material of the waveguide layer 120 and the clad layer 160 must have a wider bandgap than the active layer 130. This is because the waveguide layer 120 and the clad layer 160 should not absorb light. The waveguide layer 120 is continuously distributed over the first reflection area 102, the phase control area 103, and the second reflection area 104.

The active layer 130 has a quantum well layer structure having a composition to generate light of a predetermined basic wavelength and provide a gain. The active layer 130 includes a quantum well layer structure of a compound semiconductor InGaAsP or InGaAs under the condition that the substrate 110 is made of a compound semiconductor InP. A quantum well made of a compound semiconductor AlGaAs or GaAs is used on the substrate 110 of a compound semiconductor GaAs. However, the structure of the active layer 130 is not limited to the above-mentioned description and a bulk may be substituted for the quantum well structure. The position of active layer 130 is not limited to a portion on the waveguide layer 120.

The first reflection area 102 includes the waveguide layer 120 disposed on the substrate 110, and a first diffraction grating 140 is structurally disposed between the waveguide layer 120 and the clad layer 160. An upper electrode 172 is disposed on the clad layer 160. First selection current Id1 is received through the upper electrode 172 to vary the refractive index of the waveguide layer 120 in the first reflection area 102. Similarly, an ohmic layer (not shown) may be disposed between the upper electrode 172 and the clad layer 160.

The first diffraction grating 140 may be provided in the form of distributed Bragg reflector (hereinafter referred to as “DBR”) between the waveguide layer 120 and the clad layer 160 which have different refractive indexes. In order to form the DBR, a plurality of corrugated diffraction gratings are provided over the waveguide layer 120 by means of a partial etching process. Generally, a grating period Λ₁ of the diffraction gratings may have the magnitude of 1/2n (n being an average refractive index) times of a wavelength λ₁ which is intended to reflect. Alternatively, if necessary, the grating period Λ₁ of the diffraction gratings may have the magnitude of m/2n (n being an average refractive index, and m being a positive integer) times of the wavelength λ₁ which is intended to reflect. In this case, it is the wavelength λ₁ that is a Bragg wavelength λ_{B1} which is in the middle of a Bragg reflection band and provides the maximum reflection ratio.

The position of the first diffraction grating 140 is not limited to a portion on the waveguide layer 120. That is, a DBR-type first diffraction grating 140 may be provided beneath the waveguide layer 120, i.e., on the substrate 110. A length L₁ of the first diffraction grating 140 and a coupling constant κ₁ may be adequately controlled to selectively grant a high reflection ratio to light of only one of numerous longitudinal modes. The coupling constant κ₁ may be controlled by the depth of grooves of the respective diffraction gratings. However, when the coupling constant κ₁ and a complex parameter (κ₁×L₁) increase excessively, the reflection ratio of the first diffraction grating 140 reaches approximately 100 percent. At the same time, a wavelength band of light reflected by the first diffraction grating 140 becomes wider excessively. In this case, many longitudinal modes are reflected by similar reflection ratios to be oscillated together. Therefore, it is necessary to select a length L₁ and a coupling constant κ₁ which are suitable for suppressing this phenomenon. Namely the coupling constant κ₁ may range from approximately 30 to 300 centimeters, and the complex parameter (κ₁×L₁) may range from approximately 0.5 to 5.

The phase control area 103 includes the waveguide layer 120 disposed on the substrate 110, and the clad layer 160 is disposed on the waveguide layer 120. An upper electrode 173 is provided on the clad layer 160 for receiving phase control current Ip. Similarly, an ohmic layer (not shown) may be disposed between the upper electrode 173 and the clad layer 160.

The second reflection area 104 includes the waveguide layer 120 disposed on the substrate 110, and a second diffraction grating 150 is structurally disposed between the waveguide layer 120 and the clad layer 160. An upper electrode 174 is disposed on the clad layer 160. Second selection current Id2 is received through the upper electrode 174 to vary the refractive index of the waveguide layer 120 in the second reflection area 104. Similarly, an ohmic layer (not shown) may be disposed between the upper electrode 174 and the clad layer 160.

The second diffraction grating 150 may be provided in the same manner as the first diffraction grating 140. The second diffraction grating 150 may be provided in the form of the DBR between the waveguide layer 120 and the clad layer 160 which have different refractive indexes. In order to form the DBR, a plurality of corrugated diffraction gratings are provided over the waveguide layer 120 by means of a partial etching process. Generally, a grating period Λ₂ of the diffraction gratings may have the magnitude of 1/2n (n being an average refractive index) times of a wavelength λ₂ which is intended to reflect. Alternatively, if necessary, the grating period Λ₂ of the diffraction gratings may have the magnitude of m/2n (n being an average refractive index, m being a positive integer) times of the wavelength λ₂ which is intended to reflect. In this case, it is the wavelength λ₂ that is a Bragg wavelength λ_{B2} which is in the middle of a Bragg reflection band and provides the maximum reflection ratio.

The position of the second diffraction grating 150 is merely not limited to a portion on the waveguide layer 120. Namely, the DBR-type second diffraction grating 150 may be provided beneath the waveguide layer 120, i.e., on the substrate 110. A length L₂ of the second diffraction grating 150 and a coupling constant κ₂ may be adequately controlled to selectively grant a high reflection ratio to light of only one of numerous longitudinal modes. The coupling constant κ₂ may be controlled by the depth of grooves of the respective diffraction gratings. However, when the coupling constant κ₂ and a complex parameter (κ₂×L₂) increase excessively, the reflection ratio of the second diffraction grating 150 reaches approximately 100 percent. At the same time, a wavelength band of light reflected by the second diffraction grating 150 becomes wider excessively. In this case, many longitudinal modes are reflected by a similar reflection ratio to be oscillated together. Therefore, it is necessary to select a length L₂ and a coupling constant κ₂ which are suitable for suppressing this phenomenon.

In addition, the length L₂ of the second diffraction grating 150 must be greater than the length L₁ of the first diffraction grating 140. This is because light of the wavelength λ₂ is output through a longer resonance distance than the light of the wavelength λ₁. Free electron absorption and interface scattering cause the output light of the wavelength λ₂ to encounter relatively great light loss. That is, the second diffraction grating 150 must have a high reflection ratio to compensate the relatively great light loss and the reflection ratio of the second diffraction grating 150 is obtained by increasing a length L₂ of the diffraction grating 150.

Since the gain area 101, the first reflection area 102, the phase control area 103, and the second reflection area 104 are controlled by applying current or voltage, a structure is required for minimizing an interaction between adjacent areas. Separation grooves 181, 182, and 183 are formed between respective areas to separate adjacent operation areas. Considering the temperature, each of the separation grooves 181, 182, and 183 may be formed to have a width of at least 5 micrometers. Also each of the separation grooves 181, 182, and 183 may be formed to have an adequate perpendicular depth, i.e., neither too deep nor too shallow. That is, when the respective separation grooves 181, 182, and 183 are too deep perpendicularly, they may be coupled with an oscillation wavelength to cause additional light loss. On the other hand, when the respective separation grooves 181, 182, and 183 are too shallow perpendicularly, a poor separation between the operation areas may occur with respect to the current or temperature. While the separation grooves 181, 182, and 183 for separation from adjacent operation areas are exemplarily illustrated, the present invention is not limited thereto.

An anti-reflective coating (ARC) film 190 is disposed on a facet 122 of the second diffraction grating 150. When lights having different wavelengths λ₁ and λ₂ are output from the semiconductor laser device 100, the ARC film 190 is provided to suppress reflection of the output lights from a facet 122 of the second diffraction grating 150. If the light corresponding to the wavelength λ₁ impinges on the gain area 101 after being reflected from the facet 122 of the second diffraction grating 150, unwanted feedback effect may occur. In addition, if the light corresponding to the wavelength λ₂ impinges into a cavity (i.e., a second reflection area) after being reflected from the facet 122 of the second diffraction grating 150, a reflection ratio set by the second diffraction grating 150 may be altered.

As a result, the semiconductor laser device 100 functions as two laser cavities to resonate two lights having different wavelengths. That is, the semiconductor laser device 100 includes a first laser cavity defined by a first facet (Facet 1) 121 adjacent to the side of the gain area 101 and the first diffraction grating 140 and a second laser cavity defined by the first facet (Facet 1) adjacent to the side of the gain area 101 and the second diffraction grating 102.

The substrate 110 may be made of n-InP or n-GaAs. The waveguide layer 120 may be made of n-InGaAsP whose band gap is approximately 0.8 to 1.2 eV under the condition of an n-InP substrate. Moreover, the waveguide layer 120 may be made of n-AlGaAs whose band gap is approximately 1.5 to 1.9 eV under the condition of an n-GaAs substrate. The clad layer 160 may be made of p-InP under the condition of an n-InP substrate and may further include a current blocking structure to horizontally block paths of current provided from the electrodes 171, 172, 173, and 174. The current blocking structure may be a buried heterostructure made of at least one of p-InP and n-InP. The ARC film 190 may be made of titanium oxide, silicon oxide or a stacked structure thereof and have an adequate thickness relative to a wavelength of light. While only the substrate 110 made of n-type compound semiconductor have been described, the substrate 110 may be made of p-type compound semiconductor. In this case, the waveguide layer 120 may be made of p-type compound semiconductor while the clad layer 160 may be made of n-type compound semiconductor.

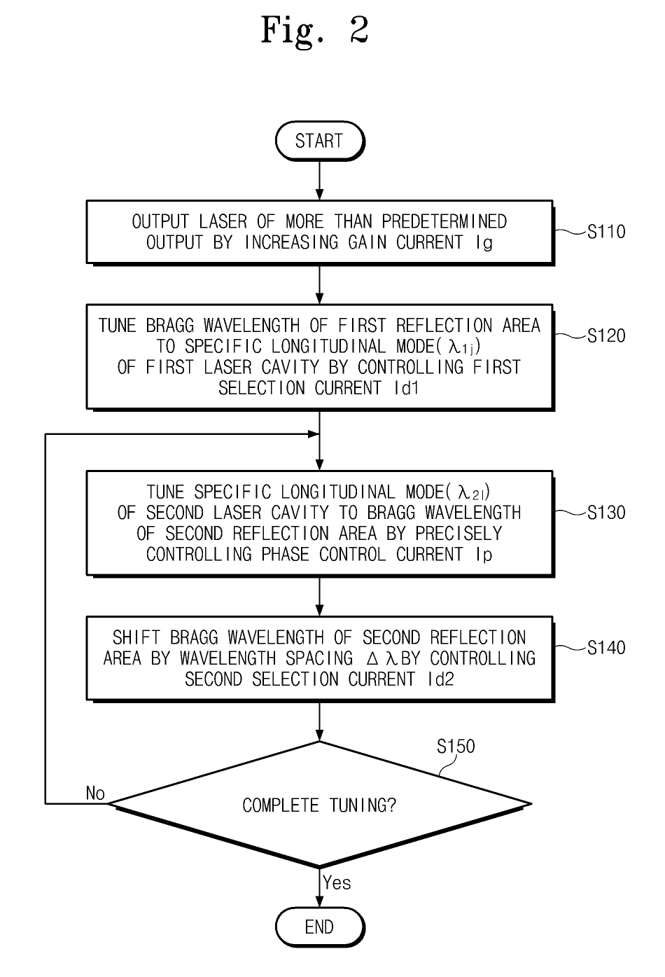

FIG. 2 is a flowchart briefly illustrating a tuning method to make one wavelength λ₁ of the output lights fixed while making the other wavelength λ₂ continuously variable in the structure described with reference to FIG. 1. As described above, the first laser cavity is defined by the facet 121 of the gain area 101 and the first diffraction grating 140 and the second laser cavity is defined by the facet 121 of the gain area 101 and the second diffraction grating 150.

The tuning method will now be described below in detail.

Gain current Ig of the gain area 101 increases to a predetermined threshold value or more to simultaneously oscillate an i^{th} longitudinal mode λ₁ᵢ of the first laser cavity and a k^{th} longitudinal mode λ₂ₖ of the second laser cavity (S110). The i^{th} longitudinal mode λ₁ᵢ of the first laser cavity is closest to the Bragg wavelength λ_{B1} of the first diffraction grating 140, and the k^{th} longitudinal mode λ₂ₖ of the second laser cavity is closest the Bragg wavelength λ_{B2} of the second diffraction grating 150.

The Bragg wavelength λ_{B1} the first diffraction grating 140 is shifted under the control of first selection current Id1 to exactly tune to a j^{th} longitudinal mode wavelength λ₁ⱼ of the first laser cavity. Thus, the maximum output is obtained. Namely, the j^{th} longitudinal mode wavelength λ₁ⱼ is tuned to be output as the fixed first wavelength λ₁. In this case, the j^{th} longitudinal mode may be a first i^{th} longitudinal mode or not. This characteristic may be achieved by controlling a refractive index or an effective refractive index of the waveguide layer 120 that is variable with the first selection current Id1 (S120).

The refractive index of the phase control area 103 is varied. That is, a longitudinal modes defined at the second laser cavity may be precisely shifted on a spectrum by finely varying the phase control current Ip. The phase control current is applied to vary a concentration or change a temperature of carriers distributed at a junction surface (p-n junction surface) between the waveguide layer 120 and the clad layer 160, which may result in change of an average refractive index of the entire second laser cavity. Due to the change of the average refractive index, the whole longitudinal modes passing through the phase control area 103 is shifted on the spectrum. As a result, a l^{th} longitudinal mode λ₂ₗ of the second laser cavity may exactly tune to the second Bragg wavelength λ_{B2} of the second diffraction grating 150. That is, the longitudinal mode λ₂₁ exactly tuning to the second Bragg wavelength λ_{B2} of the second diffraction grating 150 is output as a second wavelength λ₂. In this case, the l^{th} longitudinal mode may be the first k^{th} longitudinal mode or not (S130).

According to the control of the second selection current Id2, the second Bragg wavelength λ_{B2} set by the second diffraction grating (150 in FIG. 1) is shifted by a wavelength spacing Δλ (S140). Thereafter, this routine returns to step S130 in which a continuous spectrum is adjusted by control of the phase control current Ip. After the step S130 is again repeated, the l^{th} longitudinal mode λ₂ₗ may tune to a new Bragg wavelength to continuously oscillate. Alternatively, a new m^{th} longitudinal mode λ₂ₘ may tune to a new Bragg wavelength to continuously oscillate.

According to above-mentioned method, the second wavelength may be continuously tuned to a desired wavelength while being continuously shifted to the maximum allowable wavelength of the laser diode by arbitrary wavelength spacing Δλ. Finally, the tuning is completed by determining whether to reach the desired wavelength or not (S150).

There are various methods for tuning a specific longitudinal mode to a Bragg wavelength defined by the second diffraction grating 150 while precisely regulating phase control current Ip. The simplest one of the methods is to find the maximum output spot of the laser light while shifting the longitudinal modes to a perimeter of the Bragg wavelength, which is defined by the second diffraction grating 150, by controlling the phase control current Ip. This is because loss of a diffraction grating is lowest at the spot where the longitudinal mode fully tunes to the Bragg wavelength defined by the second diffraction grating 150.

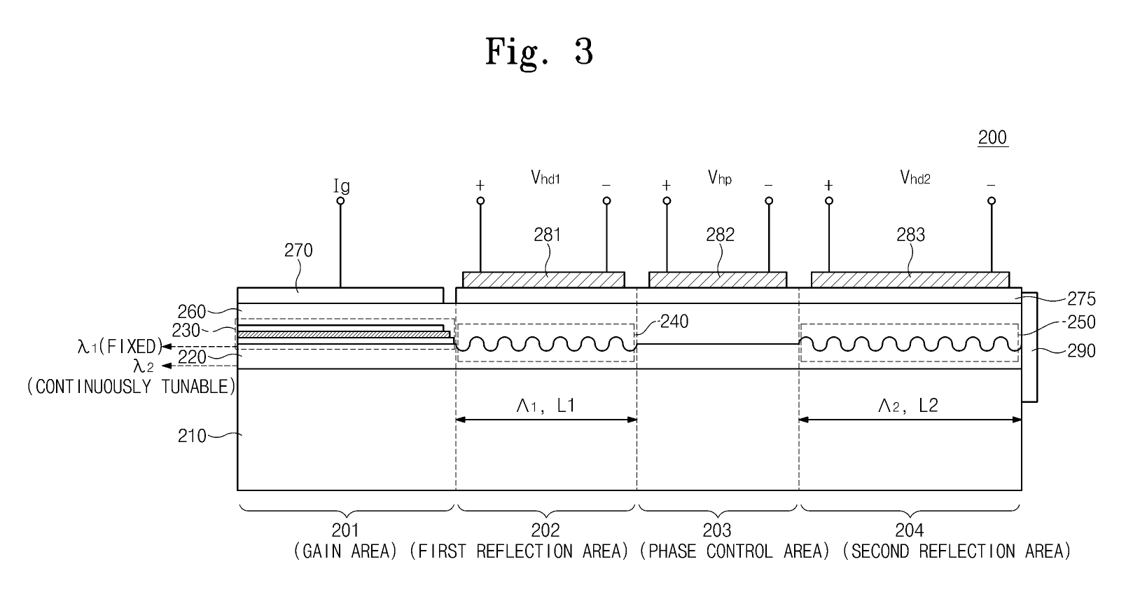

FIG. 3 is a cross sectional view briefly illustrating a semiconductor laser device 200 according to other embodiments of the present invention. The semiconductor laser device 200 includes a gain area 201, a first reflection area 202, a phase control area 203, and a second reflection area 204. Unlike the above-described semiconductor laser device 100, the semiconductor laser device 200 performs the tuning based on the temperature. The semiconductor laser device 200 is structurally similar to the semiconductor laser device 100 described with reference to FIG. 1, but it is not necessary to additionally form separation grooves.

The gain area 201 includes a waveguide layer 220 disposed on a substrate 210. An active layer 230 is disposed on the waveguide layer 220, and a clad layer 260 is disposed on the active layer 230. An upper electrode 270 is disposed on the clad layer 260. Gain current Ig is applied through the upper electrode 270. The layers constituting the gain area 201 are substantially identical to those shown in FIG. 1 and will not described in further detail.

The first reflection area 202 includes the waveguide layer 220 disposed on the substrate 210, and a first diffraction grating 240 is structurally disposed between the waveguide layer 220 and the clad layer 260. An insulation layer 275 is disposed on the clad layer 260. A metal layer 281 is deposited on the insulation layer 275. When a first selection voltage Vhd1 is applied to the metal layer 281, Joule's heat is generated by the resistance of the metal layer 281. That is, the first reflection area is controlled using the Joule's heat generated at the metal layer 282. Te first diffraction grating 240 is substantially identical to that shown in FIG. 1 and will not be described in further detail.

The phase control area 203 includes the waveguide layer 220 disposed on the substrate 210, and the clad layer 260 is disposed on the waveguide layer 220. The insulation layer 275 is disposed on the clad layer 260. A metal layer 282 is deposited on the insulation layer 275. When a phase control voltage Vhp is applied to the metal layer 282, Joule's heat is generated by the resistance of the metal layer 282. That is, the phase control area 203 is controlled using the Joule's heat generated on the metal layer 282.

The second reflection area 204 includes the waveguide layer 220 disposed on the substrate 210, and the second diffraction grating 250 is structurally disposed between the waveguide layer 220 and the clad layer 260. The insulation layer 275 is disposed on the clad layer 260. The metal layer 283 is deposited on the insulation layer 275. When a second selection voltage Vhd2 is applied to the metal layer 283, Joule's heat is generated by the resistance of the metal layer 283. That is, the second reflection area 204 is controlled by the Joule's heat generated on the metal layer 283. The second diffraction grating 250 may be provided in the same way as the first diffraction grating 240.

A structure of the semiconductor laser device 200 is similar to that of the semiconductor laser device 100 described with reference to FIG. 1, except a control way of the first reflection area 202, the phase control area 203, and the second reflection area 204. Therefore, their detailed explanations will be omitted herein.

According to the forgoing embodiments of the present invention, a refractive index or a reflection ratio is controlled by applying currents Id1, Ip, and Id2. Due to the applied currents Id1, Ip, and Id2, carrier concentration and temperature of the waveguide layer 120 are altered at the same time. However, the increased carriers result in decease of the reflection ratio, while the increased temperature results in increase of the refractive index of the waveguide layer 120. That is, the applied currents Id1, Ip, and Id2 cause characteristic change to occur contrariwise. Especially, these characteristics frequently appear at the timing of applying low-level current. These characteristics may result in complexity of a control scheme. Moreover, the increase of carrier concentration causes an additional absorption of free electrons. Therefore, it is possible to change the output characteristic of laser.

The above-described embodiment provides a structure using only a temperature as a control parameter. It is therefore possible to embody a semiconductor laser device in consideration of only variation of a refractive index with temperature among various parameters.

To sum up, a semiconductor laser device according to the present invention can provide a semiconductor optical device having a fixed one of two output light wavelengths and a continuously tunable wavelength.

Although the present invention has been described in connection with the exemplary embodiments of the present invention, it will be apparent to those skilled in the art that various modifications and changes may be made thereto without departing from the scope and spirit of the invention. Therefore, it should be understood that the above embodiments are not limitative, but illustrative in all aspects.

What is claimed is:

1. A semiconductor laser device comprising:
a gain area where multi-wavelength lights are generated and gains are provided;
a first reflection area where among the multi-wavelength lights, a first-wavelength light is reflected to the gain area in response to a first selection signal;
a second reflection area where among the multi-wavelength lights, a second-wavelength light is reflected to the gain area; and
a phase control area where a phase of the second-wavelength light is shifted in response to a phase control signal, the phases control area being disposed between the first reflection area and the second reflection area.

2. The semiconductor laser device of claim 1,
wherein the gain area includes:
an active layer generating the multi-wavelength light and providing gains in response to gain current;
a waveguide layer guiding the multi-wavelength lights;
a lower clad layer disposed above the waveguide layer and the active layer; and
an upper clad layer disposed below the waveguide layer and the active layer.

3. The semiconductor laser device of claim 2,
wherein the first reflection area includes:
a first reflection waveguide layer extending to the waveguide layer;
a first lower clad layer disposed below the first reflection waveguide layer;
a first upper clad layer disposed above the first reflection waveguide layer; and
a first electrode provided to input the first selection signal to the first reflection area.

4. The semiconductor laser device of claim 3,
wherein the first reflection waveguide layer or a portion of the first upper or lower clad layer is disposed with a structure of a first diffraction grating provided to have a reflection ratio at which the first wavelength light is reflected.

5. The semiconductor laser device of claim 4,
wherein the phase control area includes:
a phase control waveguide layer extending to the first reflection waveguide layer;
a second lower clad layer disposed below the phase control waveguide layer;
a second upper clad layer disposed above the phase control waveguide layer; and
a second electrode provided to input the phase control signal to the phase control area.

6. The semiconductor laser device of claim 5,
wherein the second reflection area includes:
a second reflection waveguide layer extending to the phase control waveguide layer;
a third lower clad layer disposed below the second reflection waveguide layer;
a third upper clad layer disposed above the second reflection waveguide layer; and
a third electrode provided to input the second selection signal to the second reflection area.

7. The semiconductor laser device of claim 6,
wherein the second reflection waveguide layer or a portion of the third upper or lower clad layer is disposed with a structure of a second diffraction grating provided to have a reflection ratio at which the second wavelength light is reflected.

8. The semiconductor laser device of claim 7,
wherein the second diffraction grating is longer than the first diffraction grating.

9. The semiconductor laser device of claim 2,
wherein the first reflection area includes:
a first reflection waveguide layer extending to the waveguide layer;
a first lower clad layer disposed below the first reflection waveguide layer;
a first upper clad layer disposed above the first reflection waveguide layer; and
a first metal thin film layer disposed to generate Joule's heat in response to the first selection signal.

10. The semiconductor laser device of claim 9,
wherein the phase control area includes:
a phase control waveguide layer extending to the first reflection waveguide layer;
a second lower clad layer disposed below the phase control waveguide layer;
a second upper clad layer disposed above the phase control waveguide layer; and
a second metal thin film layer disposed to generate Joule's heat in response to the phase control signal.

11. The semiconductor laser device of claim 10,
wherein the second reflection area includes:
a second reflection waveguide layer extending to the phase control waveguide layer;
a third lower clad layer disposed below the second reflection waveguide layer;
a third upper clad layer disposed above the second reflection waveguide layer; and
a third metal thin film layer disposed to generate Joule's heat in response to the second selection signal.

12. The semiconductor laser device of claim 11, further comprising:
an insulation layer disposed below each of the first to third metal thin film layers.

13. The semiconductor laser device of claim 1, wherein an anti-reflective coating layer is disposed on a facet of the second reflection area to prevent reflection of the first wavelength light or the second wavelength light.
